(19) United States
(12) Patent Application Publication
(10) Pub. No.: US 2013/0058381 A1
(43) Pub. Date: Mar. 7, 2013

(54) NONLINEAR SIGNAL PROCESSING METHOD AND APPARATUS FOR PULSED-BASED ULTRA-WIDEBAND SYSTEM

(71) Applicants: Zhizhang Chen, Halifax (CA); Hong Nie, Calgary (CA); Zhimeng Xu, Fuzhou (CN)

(72) Inventors: Zhizhang Chen, Halifax (CA); Hong Nie, Calgary (CA); Zhimeng Xu, Fuzhou (CN)

(21) Appl. No.: 13/600,681

(22) Filed: Aug. 31, 2012

Related U.S. Application Data
(60) Provisional application No. 61/529,949, filed on Sep. 1, 2011.

(51) Int. Cl. H04B 1/707

(52) U.S. Cl. 375/147; 375/E01.003

(57) ABSTRACT

A method and apparatus are provided for processing a received pulsed-based ultra-wideband (UWB) signal before the signal is demodulated by an energy detection based receiver. A nonlinear signal processing unit contains one or multiple subunits, and each subunit consists of a nonlinear device and a filter. The nonlinear devices can be any devices that can shift signal, noise, and interference spectra in a nonlinear fashion, and include but are not limited to square law devices and Teager-Kaiser operators. By applying the nonlinear signal processing unit on the received UWB signal, a major part of the energy of noise and narrowband interferences is shifted to specific frequency ranges and then removed by the appropriate filter(s) in the nonlinear signal processing unit. Thus, the signal-to-noise-plus-interference ratio (SNIR) of the received UWB signal can be improved.

### FIELD OF THE INVENTION

The invention relates generally to ultra-wideband (UWB) communication systems, and more particularly to energy detection (ED) based receivers for pulse-based UWB systems.

### BACKGROUND OF THE INVENTION

UWB systems have a frequency bandwidth equal to or greater than 500 MHz or 20% of its central frequency, which makes it possible to use very short duration pulses instead of continuous sinusoidal carrier waves to transmit information. Consequently, pulse-based UWB technology is foreseen to be a key technology for developing high data rates as well as high-accuracy ranging communication systems with ultra low-power consumption and low-complexity.

FIG. 1 shows a match-filter based receiver structure for pulse-based UWB systems. The received signal comprises the transmitted signal, any narrowband interferences (NBIs), and noise. In the receiver, the received signal is first amplified by a low noise amplifier (LNA), and filtered by a band-pass filter (BPF) to remove out-of-band noise and interferences. Then the BPF output is correlated with a stored signal template, Sₜₑₘₚₗₐₜₑ(ₜ). The correlation output is integrated over a certain interval, typically equal to signal duration, and then sampled. Finally, an appropriate signal processing algorithm is applied to recover the transmitted information from the sampled signal. In order to achieve an optimum performance, the match-filter based receiver must tackle a major technical challenge: the signal template must be perfectly matched to the noise-and-interference-free waveform of the received signal. However, in UWB systems, due to ultra wide bandwidth and serious multipath fading, the waveform of the received signal is very different from that of the transmitted signal and varies continuously in time. Estimating the waveform of the received signal leads to unacceptably high complexity for the match-filter based receiver.

Whereas low-complexity pulse-based UWB transmitters are feasible, a considerable part of the research has been shifted towards the design of suboptimum, non-coherent schemes, such as energy detection (ED) based receiver architectures. FIG. 2 shows the structure for an ED based receiver. In the ED based receiver, the received signal is first amplified by a LNA and filtered by a BPF to remove out-of-band noise and interferences. Then the BPF output is squared, integrated over a certain interval, and sampled. Finally, an appropriate digital signal processing algorithm is applied to recover the transmitted information from the sample signal. Typical signaling schemes that can use the ED based receiver include on-off keying (OOK), pulse-position modulation (PPM), frequency-shifted reference (FSR), code-shifted reference (CSR), and differential code-shifted reference (DCSR). For each signaling scheme, a corresponding information recovery algorithm should be applied to recover information according to the energy of the received signal.

As compared to the match-filter based receiver, the ED based receiver does not need to estimate the waveform of the received signal, and hence has a much lower system complexity. However, a drawback of the ED based receiver is that the energy of noise and interferences in the received UWB signal is also collected and considered as signal energy. Thus, the ED based receiver is sensitive to noise and interferences. Because UWB systems operate over extremely wide frequency bands, they have to co-exist with NBIs from existing communication systems. Moreover, even though the NBIs only occupy a very small fraction of the bandwidth utilized by the UWB systems, they may operate at much higher power levels, e.g., see 47 C.F.R 15, Subpart F: Ultra-wideband, and the IEEE 802.15.4a standard. Consequently, they can seriously degrade the performance of the ED based receiver. Therefore, it is critical to apply NBI mitigation technologies to mitigate the destructive effects of NBIs on the ED based receiver for pulsed-based UWB systems.

Most existing NBI mitigation technologies, such as a filter bank approach, an adaptive notch filter approach, and an interference estimation and cancellation approach, are based on linear signal processing techniques, and they have the following major disadvantages. First, accurate information about the statistical characteristics of NBIs, such as center frequencies, signal power, signal bandwidth, is required. However, for most UWB applications such information is unknown and varies with time. Second, the complexity to implement those technologies can be high. For the technologies mitigating NBIs in the digital domain, analog-to-digital converters (ADCs) with ultra high sampling rate are required to digitize the received UWB signal. For the technologies mitigating NBIs in the analog domain, a group of analog filters are required.

Recently, a NBI mitigation technology based on nonlinear signal processing techniques has been developed for OOK signaling schemes. In this technology, before demodulated by the ED based receiver, the received UWB signal is first processed by a nonlinear device called a Teager-Kaiser operator (TKO), the mathematical input/output relation of which is given by:

y(t)=[\dot{x}(t)]²−x(t)\ddot{x}(t).

When a UWB signal, corrupted by a single NBI, is applied to the TKO, most energy of the NBI is shifted to a frequency range close to DC. Thus, by applying a high pass filter (HPF) on the output of the TKO, the destructive effect of the NBI can be mitigated. However, when two or more NBIs exist, this technique has a poor mitigation performance.

### SUMMARY OF THE INVENTION

In accordance with one aspect of the invention, an energy detection based receiver for receiving and processing UWB signals is provided. The receiver includes an amplifier for amplifying a received UWB signal. The receiver also includes a bandpass filter to remove out-of-band noise and out-of-band interference. The receiver also includes a nonlinear signal processing unit comprising at least one subunit. Each subunit has a nonlinear device which shifts an input signal in frequency and a filter, the filter of each subunit arranged to receive signals from the corresponding nonlinear device of the subunit. At least one of the at least one nonlinear device is other than a Teager-Kaiser Operator.

In accordance with another aspect of the invention, a method of processing a UWB signal is provided. The signal is amplified, and then filtered to remove out-of-band noise and out-of-band interference. One or more times, the frequency of the filtered signal is then shifted using a nonlinear device and the signal is then filtered using a subunit filter. At least one nonlinear device is other than a Teager-Kaiser Operator.

The methods of the invention may be stored as processing instructions on non-transitory computer-readable storage media.

The embodiments of the invention build a nonlinear signal processing unit and add it into the ED bases receiver for pulse based UWB systems. The nonlinear signal processing unit contains one or multiple subunits, and each subunit consists of a nonlinear device and a filter. The nonlinear devices used in the nonlinear signal processing unit include but are not limited to square law devices, Teager-Kaiser operators, and quadruple-law devices. The filters can be highpass filters (HPFs) or bandpass filters (BPFs). Using a proper combination of multiple nonlinear devices allows the destructive effects of two or even more NBIs to be mitigated. These nonlinear devices can also be used for noise reduction and improve performance of the ED based receiver even when no NBIs exist.

When the received UWB signal that is corrupted by noise and NBIs passes through the nonlinear signal processing unit, a major part of the energy of noise and NBIs is shifted to a specific frequency range (such as DC and/or high frequency range), and removed by the appropriate filter(s) in the nonlinear signal processing unit. Thus, the invention is capable of suppressing both noise and NBIs with a very low complexity, and increase the robustness of the ED based receiver to noise and NBIs.

The invention can be applied to all pulse based UWB signaling schemes that use the ED based receiver as their detector, such as OOK, PPM, FSR, CSR, and DCSR.

The methods and apparatus described herein invention can reduce the energy of noise and narrowband interferences (NBIs) in the received UWB signal and improve its signal-to-noise-plus-interference ratio (SNIR). The number and/or type of nonlinear devices beyond a single TKO is provided and added into an ED based receiver to not only mitigate NBIs but also reduce noise for various pulse based UWB systems.

### BRIEF DESCRIPTION OF THE DRAWINGS

The features and advantages of the invention will become more apparent from the following detailed description of the preferred embodiment(s) with reference to the attached figures, wherein:

FIG. 1 is a block diagram of a match-filter based receiver structure;

FIG. 2 is a block diagram of an energy detection based receiver structure;

FIG. 3 is a block diagram of an energy detection based receiver structure according to one embodiment of the invention;

FIG. 4 is a block diagram of the general structure of the Nonlinear Unit of FIG. 3 according to one embodiment of the invention;

FIG. 5 is a block diagram of the Nonlinear Unit of FIG. 3 for when no or one narrowband interference is present, according to one embodiment of the invention;

FIG. 6 is a frequency diagram of the received signal when one narrowband interference is present;

FIG. 7 is a frequency diagram of the signal of FIG. 6 after being processed by the Nonlinear Unit of FIG. 3 according to one embodiment of the invention;

FIG. 8 is a frequency diagram of the received signal when two narrowband interferences are present;

FIG. 9 is a block diagram of the Nonlinear Unit of FIG. 3 for when two narrowband interferences are present, according to one embodiment of the invention;

FIG. 10 is a frequency diagram of the signal of FIG. 8 after being processed by the square law device of FIG. 9;

FIG. 11 is a frequency diagram of the signal of FIG. 10 after being processed by the BPF of FIG. 9; and

FIG. 12 is a frequency diagram of the signal of FIG. 11 after being processed by the TKO of FIG. 9.

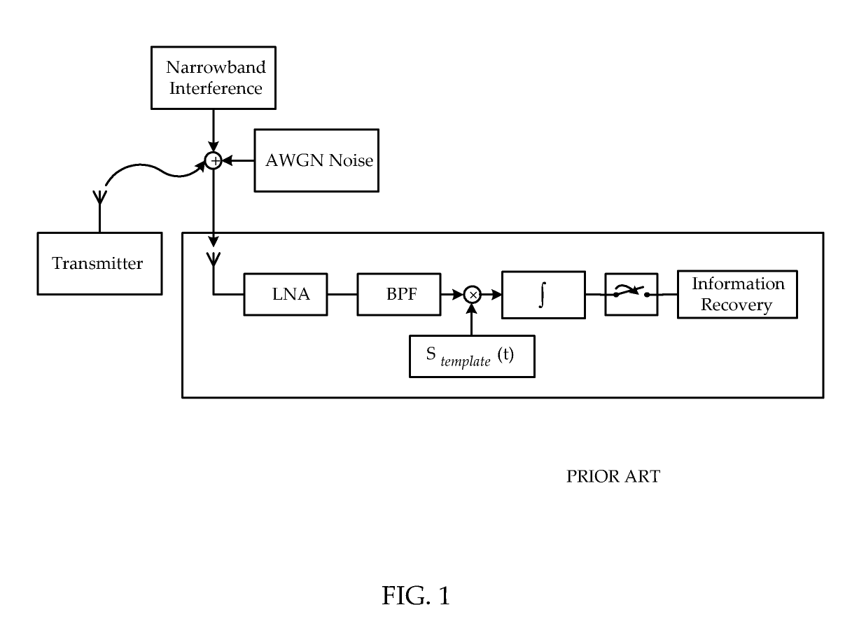

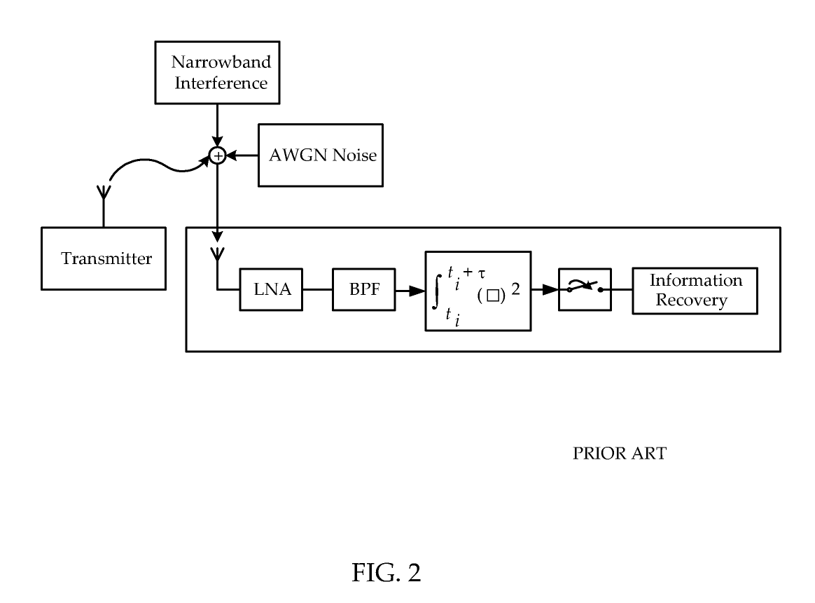

It will be noted that in the attached figures, like features bear similar labels.

### DETAILED DESCRIPTION OF THE EMBODIMENTS

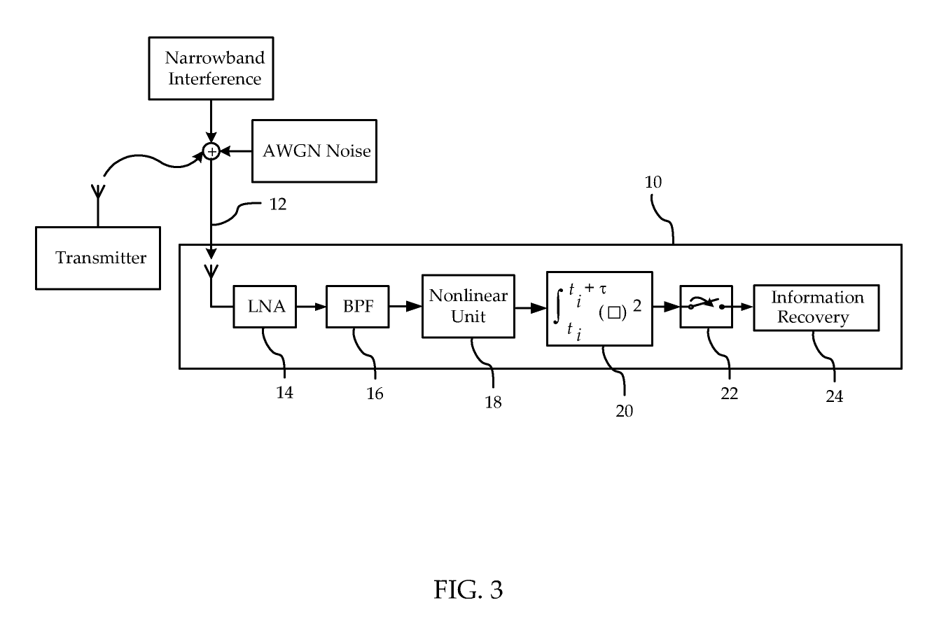

Referring to FIG. 3, the structure of an energy detection (ED) based receiver that includes a nonlinear signal processing unit is shown according to one embodiment of the invention. When the ED based receiver 10 receives a received signal 12, the received signal passes through a low noise amplifier (LNA) 14, and then through a bandpass filter (BPF) 16 to remove out-of-band noise and out-of-band interferences. The amplified and filtered signal then passes to a Nonlinear Unit 18. The Nonlinear Unit 18 is a nonlinear signal processing unit, described in more detail below. After frequency shifting and filtering by the Nonlinear Unit 18, as described below, the signal is passed to an integrator 20 which integrates the square of the signal over a certain interval, and then passed to a sampler 22 to be sampled. Finally, an information recovery unit 24 applies an appropriate digital signal processing algorithm to recover the transmitted information from the sample signal. The digital signal processing algorithm applied by the information recovery unit 24 reflects the coding used to generate the UWB signal, such as OOK, PPM, FSR, CSR, or DCSR.

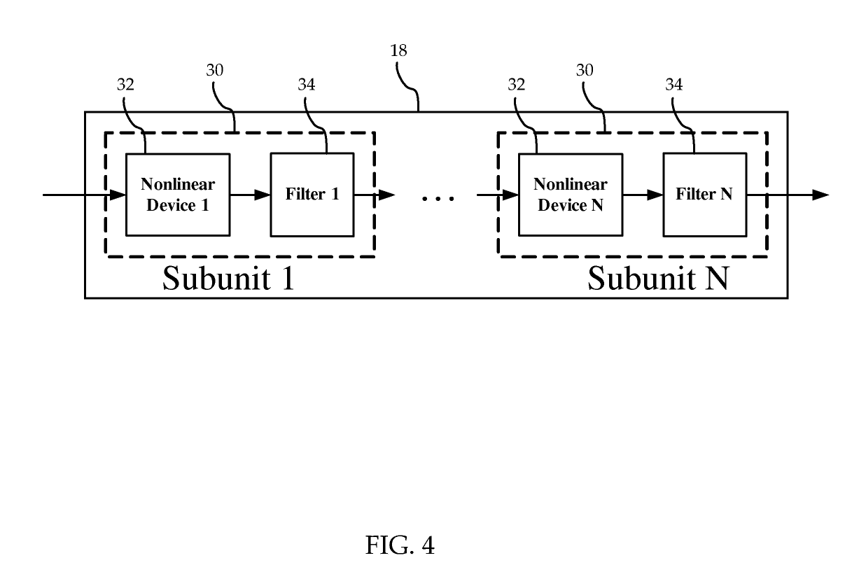

Referring to FIG. 4, the structure of the Nonlinear Unit 18 of FIG. 3 is shown according to one embodiment of the invention. The Nonlinear Unit 18 contains one or multiple subunits 30. If there is more than one subunit within the Nonlinear Unit 18, the subunits are arranged sequentially in the direction of processing of the signal. Each subunit 30 comprises a nonlinear device 32 and a filter 34. The nonlinear devices used in the nonlinear signal processing unit are any devices that can shift spectra of the received signals in a nonlinear fashion. They include but are not limited to square law devices, Teager-Kaiser operators, and quadruple-law devices. At least one of the one of more nonlinear devices is other than a Teager-Kaiser operator, such as a square law device. The filters can be highpass filters (HPFs) or bandpass filters (BPFs).

Because the complexity to build a TKO is much higher than to that to build a square law device and the illustration is simpler with a square law device, the description of the embodiments below uses square law devices in the Nonlinear Unit whenever possible. More generally however, any nonlinear device that performs similar functions can be used.

The UWB signal under consideration is assumed to be within a frequency range from f_{L} to f_{H}, because almost all pulse based UWB systems operated satisfy f_{H}<3f_{L}. Examples of different nonlinear signal processing units are described below for various scenarios. These are examples embodiments only, and variations of structure, such as use of different nonlinear devices, may be used.

Scenario I: No NBI

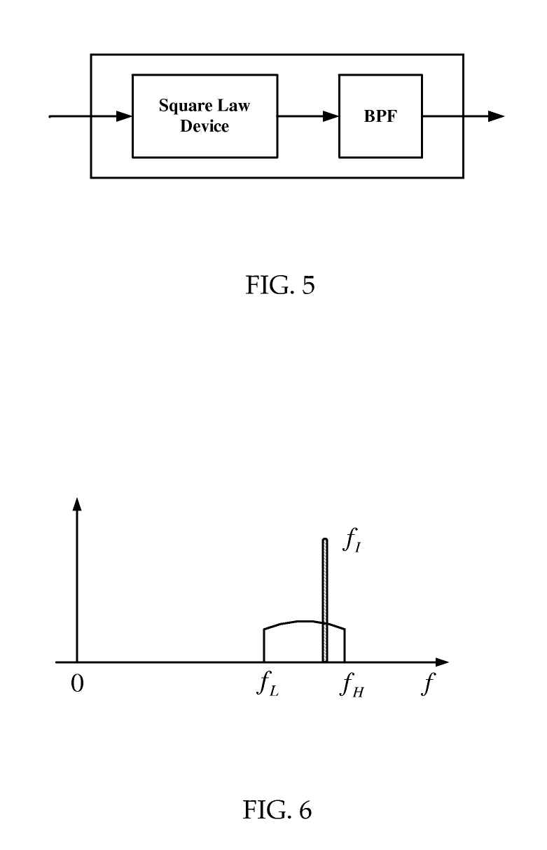

When no NBI is present, the main function of the nonlinear signal processing unit is to reduce the noise energy. Under this scenario, the nonlinear signal processing unit contains only one subunit that consists of a square law device and a BPF, as shown in FIG. 5.

When the received UWB signal corrupted by noise passes through the square law device, a major part of the energy of the noise is shifted to DC. Thus, applying a BPF to remove DC can reduce the energy of noise while maintain most energy of the UWB signal.

Scenario II: One NBI

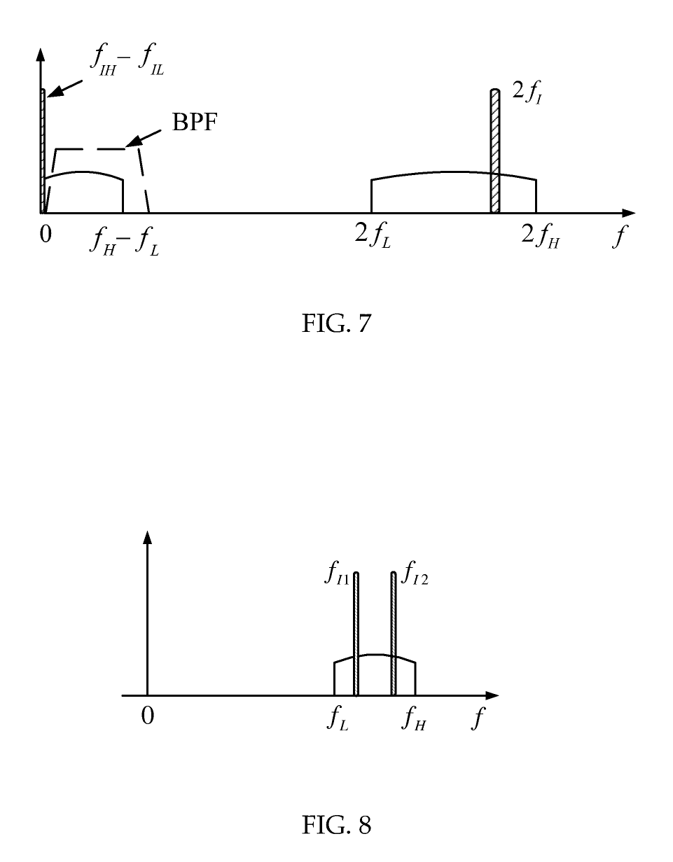

Under this scenario, also as shown in FIG. 5, the nonlinear signal processing unit contains only one subunit that consists of a square law device and a BPF. The received signal is shown in FIG. 6, where an NBI with a center frequency of f_{I} is present. As shown in FIG. 7, when the UWB signal passes through the square law device in the nonlinear signal processing unit, the output UWB signal is located at:
(i) DC,
(ii) DC to f_{H}−f_{L}, and
(iii) 2f_{L} to 2f_{H}.

Similarly, when a NBI with a frequency range between f_{IL} and f_{IH} passes through the square law device in the nonlinear signal processing unit, the output NBI signal is located at:
(i) DC,
(ii) DC to f_{IH}−f_{IL}, and
(iii) 2f_{IL} to 2f_{IH}with its center frequency at 2f_{I}.

Thus, a BPF with a passing band between f_{IH}−f_{IL} and f_{H}−f_{L} can remove most energy of the NBI and maintain most energy of the UWB signal. In other words, the components of the signal blocked by the bandpass filter are a low-frequency component close to DC and high frequency components beyond about twice the lowest frequency (i.e. 2f_{L}) of the received UWB signal.

Scenario III: Two NBIs

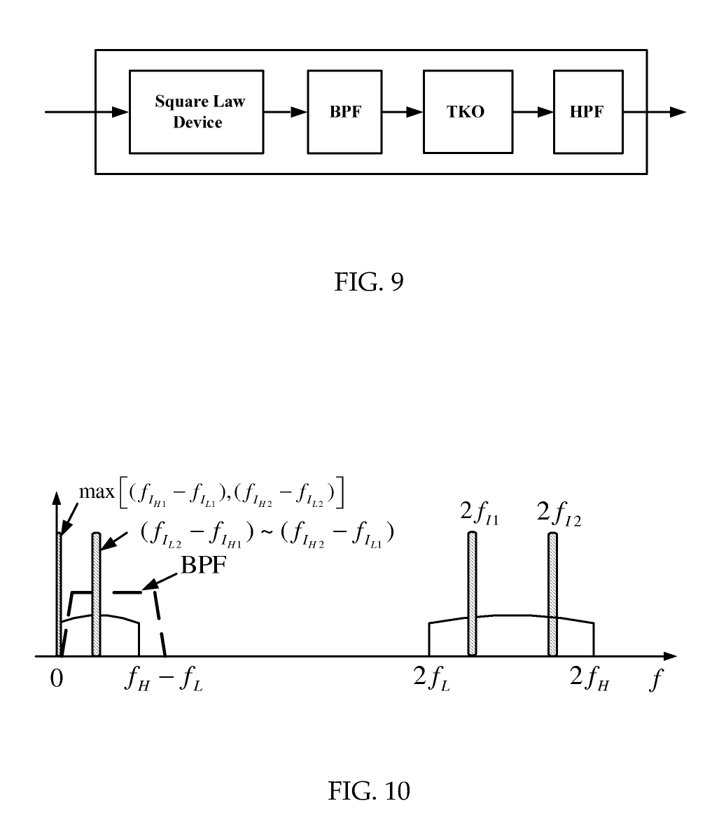

FIG. 8 illustrates a frequency diagram of the received signal when two NBIs are present. Under this scenario the nonlinear signal processing unit contains two subunits, as shown in FIG. 9. The first subunit consists of a square law device and a BPF, and the second subunit consists of a TKO and a HPF. As shown in FIG. 10, when the UWB signal passes through the square law device in the first subunit, the output UWB signal is located at:
(i) DC,
(ii) DC to f_{H}−f_{L}, and
(iii) 2f_{L} to 2f_{H}.

When the two NBIs pass through the square law device in the first subunit, the output NBI signal is located at:
(i) DC,
(ii) DC to max (f_{IH1}−f_{IL1}, f_{IH2}−f_{IL2}),
(iii) f_{IL2}−f_{IH1} to f_{IH2}−f_{IL1},
(iv) 2f_{IL1} to 2f_{IH1} with its center frequency at 2f_{I1}, and
(v) 2f_{IL2} to 2f_{IH2} with its center frequency at 2f_{I2}.

Thus, a BPF with a passing band between max (f_{IH1}−f_{IL1}, f_{IH2}−f_{IL2}) and f_{H}−f_{L} can remove most energy of the NBI except the one with a frequency range between f_{IL2}−f_{IH1} and f_{IH2}−f_{IL1}, and maintain most energy of the UWB signal. In other words, the components of the signal blocked by the bandpass filter are a low-frequency component close to DC and high frequency components beyond about twice the lowest frequency (i.e. 2f_{I}) of the received UWB signal. The output of the BPF is illustrated in FIG. 11.

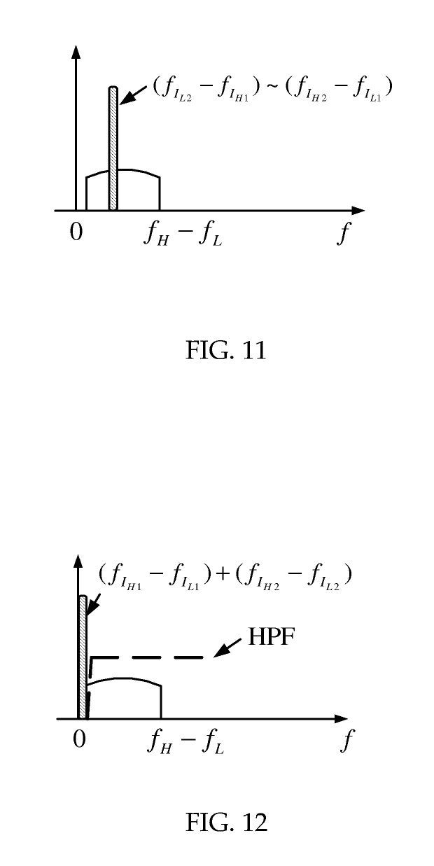

As shown in FIG. 12, when the UWB signal outputted by the first subunit passes through the TKO in the second subunit, the output UWB signal is located at:
(i) DC, and
(ii) DC to f_{H}−f_{L}.

When the NBI with a frequency range between f_{IL2}−f_{IH1} and f_{IH2}−f_{IL1} passes through the TKO in the second subunit, the output NBI signal is located at:
(i) DC, and
(ii) DC to f_{IH1}−f_{IL1}+f_{IH2}−f_{IL2}.

Thus, a HPF with a stop band at f_{IH1}−f_{IL1}+f_{IH2}−f_{IL2} can remove most energy of the NBI and maintain most energy of the UWB signal. In other words, the component of the signal blocked by the highpass filter is a low-frequency component close to DC.

The Nonlinear Unit is preferably implemented as hardware in an ED receiver. For example, the at least one nonlinear device within the Nonlinear Unit may be carried out by one or more integrated circuits, as may the at least one filter. The Nonlinear Unit may alternatively be implemented as software loaded onto a computer processor or other device which performs the nonlinear spectra shifting and the filtering described above, although this is less preferable since it may result in slower processing of signals. The functionality of the Nonlinear Unit could also be implemented as a combination of software and hardware. If in the form of software, the logical instructions of the functionality of the Nonlinear Unit may be stored on one or more non-transitory computer-readable storage media.

The embodiments presented are exemplary only. In general, the Nonlinear Signal Processing Unit contains at least one subunit, each subunit containing a nonlinear device and a filter. Each nonlinear device may be any kind of nonlinear device, including but not limited to a square law device, a quadruple law device, and a TKO. Each filter may be either a HPF or a BPF. Persons skilled in the art would appreciate that variations to the embodiments described above may be made without departing from the spirit of the invention.

We claim:

1. An energy detection based receiver for receiving and processing UWB signals, comprising:
an amplifier for amplifying a received UWB signal;
a bandpass filter to remove out-of-band noise and out-of-band interference; and
a nonlinear signal processing unit comprising at least one subunit, each subunit having a nonlinear device which shifts an input signal in frequency and a filter, the filter of each subunit arranged to receive signals from the corresponding nonlinear device of the subunit, and wherein at least one of the at least one nonlinear device is other than a Teager-Kaiser Operator.

2. The energy detection based receiver of claim 1 wherein there is one subunit and wherein the nonlinear device of the subunit is a square law device.

3. The energy detection based receiver of claim 2 wherein the filter of the subunit is a bandpass filter.

4. The energy detection based receiver of claim 3 wherein the bandpass filter of the subunit removes a low-frequency component close to DC and high frequency components beyond about twice the lowest frequency of the received UWB signal.

5. The energy detection based receiver of claim 1 wherein there are two subunits arranged sequentially, the nonlinear device of at least one of the subunits being a square law device.

6. The energy detection based receiver of claim 5 wherein one of the nonlinear devices is a Teager-Kaiser Operator (TKO), wherein the filter in the subunit having the square law device is a bandpass filter, and wherein the filter in the subunit having the TKO is a highpass filter.

7. The energy detection based receiver of claim 6 wherein the bandpass filter of the subunit having the square law device removes a low-frequency component close to DC and high frequency components beyond about twice the lowest frequency of the received UWB signal, and wherein the highpass filter of the subunit having the TKO removes a low-frequency component close to DC .

8. A method of processing a UWB signal, comprising:
amplifying the signal;
filtering the amplified signal to remove out-of-band noise and out-of-band interference; and
once or more:
shifting the frequency of the filtered signal using a nonlinear device; and
filtering the frequency shifted signal using a subunit filter,
wherein at least one nonlinear device is other than a Teager-Kaiser Operator.

9. The method of claim 8 wherein shifting the frequency of the filtered signal and subsequent filtering occurs only once, and wherein the nonlinear device is a square law device.

10. The method of claim 8 wherein shifting the frequency of the filtered signal and subsequent filtering occurs twice, wherein the nonlinear device used in the first frequency shifting is a square law device, and wherein the nonlinear device used in the second frequency shifting is a Teager-Kaiser Operator.
